(19) United States
(12) Patent Application Publication
(10) Pub. No.: US 2012/0023426 A1
(43) Pub. Date: Jan. 26, 2012

(54) Apparatuses and Methods for Position Adjustment of Widget Presentations

(75) Inventors: Yuan-Chung SHEN, Taipei City (TW); Cheng-Hung KO, Taipei City (TW)

(73) Assignee: MEDIATEK INC., Hsin-Chu (TW)

(21) Appl. No.: 12/841,824

(22) Filed: Jul. 22, 2010

(51) Int. Cl. G06F 3/048

(52) U.S. Cl. 715/769

(57) ABSTRACT

An electronic interaction apparatus for position adjustment of widget presentations is provided. In the electronic interaction apparatus, a touch screen comprising a first area and a second area is coupled thereto. A processing unit determines that an image of a widget is dragged and dropped within the second area. Also, the processing unit adjusts the dropped image back to the first area.

### BACKGROUND OF THE INVENTION

1. Field of the Invention

The invention generally relates to widget presentations, and more particularly, to apparatuses and methods for position adjustment of widget presentations.

2. Description of the Related Art

To an increasing extent, touch screens are being used for electronic devices, such as computers, mobile phones, media player devices, and gaming devices, etc., as human-machine interfaces. The touch screen may comprise a plurality of touch-sensitive sensors for detecting the contact of objects thereon; thereby, providing alternatives for user interaction therewith, for example, by using pointers, styluses, fingers, etc. Generally, the touch screen may be provided with a graphical user interface (GUI) for a user to view current statuses of particular applications or widgets, and the GUI is provided to dynamically display the interface in accordance with a selected widget or application. A widget provides a single interactive point for direct manipulation of a given kind of data. In other words, a widget is a basic visual building block associated with an application, which holds all the data processed by the application and provides available interactions on this data. Specifically, a widget may have its own functions, behaviors, and appearances.

Each widget that is built into electronic devices is usually used to implement distinct functions and further generate specific data in distinct visual presentations. The visual presentation of each widget may be displayed through the GUI provided by the touch screen. Generally, a user may interact with a widget by generating specific touch events upon visual presentation of the widget. For example, a user may drag the visual presentation of a widget from one position to another by sliding a pen on the touch screen. However, there are situations where the visual presentation of the widget may be dragged to a position outside of the valid area of the GUI on the touch screen, causing lack of control over the widget, i.e., the user can not interact with the widget anymore. Thus, an error-free and guaranteed method for a user to control and interact with a widget is required.

### BRIEF SUMMARY OF THE INVENTION

Accordingly, embodiments of the invention provide apparatuses and methods for real time widget interactions. In one aspect of the invention, an electronic interaction apparatus is provided. The electronic interaction apparatus comprises a touch screen and a processing unit. The touch screen comprises a first area and a second area. The processing unit determines that an image of a widget is dragged and dropped within the second area, and adjusts the dropped image back to the first area.

In another aspect of the invention, a method for position adjustment of widget presentations in an electronic interaction apparatus with a touch screen comprising a first area and a second area is provided. The method comprises the steps of determining that an image of a widget is dragged by detecting a series of continuous contacts or approximations of an object on an image of the widget displayed on the touch screen, detecting that the image is dragged and dropped within the second area at a termination of the dragging; and moving the dropped image back to the first area.

Other aspects and features of the present invention will become apparent to those with ordinarily skill in the art upon review of the following descriptions of specific embodiments of the apparatus and methods for position adjustment of widget presentations.

### BRIEF DESCRIPTION OF DRAWINGS

The invention can be more fully understood by reading the subsequent detailed description and examples with references made to the accompanying drawings, wherein:

FIG. 1 is a simplified block diagram illustrating an elevated view of an electronic interaction apparatus with a touch screen in accordance with an embodiment of the invention;

FIG. 2 is a block diagram illustrating the system architecture of the electronic interaction apparatus 1 of FIG. 1;

FIG. 3 is an exemplary display screen of the touch screen 16 of FIG. 1;

FIG. 4A is a schematic diagram illustrating adjustment for the dropped image 300 whose center is in the area A3;

FIG. 4B is a schematic diagram illustrating adjustment for the dropped image 300 whose center is outside of the touch screen 16;

FIG. 5 is a schematic diagram illustrating adjustment for the dropped image 300 whose predetermined part is partially outside of the touch screen 16;

FIG. 6 shows a schematic diagram of a drag event with signals s2 to s4 on the touch screen 16 according to an embodiment of the invention; and

FIG. 7 is a flow chart illustrating the position adjustment method for widget presentations in the electronic interaction apparatus 1 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof

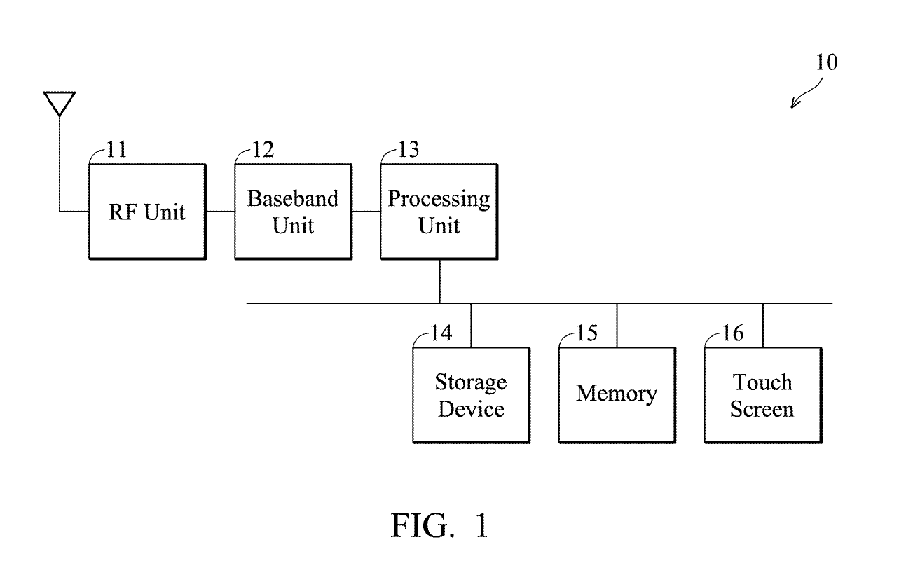

FIG. 1 is a block diagram of a mobile station according to an embodiment of the invention. The mobile phone 10 is equipped with a Radio Frequency (RF) unit 11 and a Baseband unit 12 to communicate with a corresponding node via a cellular network. The Baseband unit 12 may contain multiple hardware devices to perform baseband signal processing, including analog to digital conversion (ADC)/digital to analog conversion (DAC), gain adjusting, modulation/demodulation, encoding/decoding, and so on. The RF unit 11 may receive RF wireless signals, convert the received RF wireless signals to baseband signals, which are processed by the Baseband unit 12, or receive baseband signals from the baseband unit 12 and convert the received baseband signals to RF wireless signals, which are later transmitted. The RF unit 11 may also contain multiple hardware devices to perform radio frequency conversion. For example, the RF unit 11 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the radio access technology (RAT) in use. The mobile phone 10 is further equipped with a touch screen 16 as part of a man-machine interface (MMI). The MMI is the means by which people interact with the mobile phone 10. The MMI may contain screen menus, icons, text messages, and so on, as well as physical buttons, keypad and the touch screen 16, and so on. The touch screen 16 is a display screen that is sensitive to the touch or approximation of a finger or stylus. The touch screen 16 may be the resistive or capacitive type, or others. Users may manually touch, press, or click the touch screen to operate the mobile phone 10 with the indication of the displayed menus, icons or messages. A processing unit 13 of the mobile phone 10, such as a general-purposed processor or a micro-control unit (MCU), or others, loads and executes a series of program codes from a memory 15 or a storage device 14 to provide functionality of the MMI for users. It is to be understood that the introduced methods for real time widget interaction may be applied to different electronic apparatuses, such as portable media players (PMP), global positioning system (GPS) navigation devices, portable gaming consoles, and so on, without departing from the spirit of the invention.

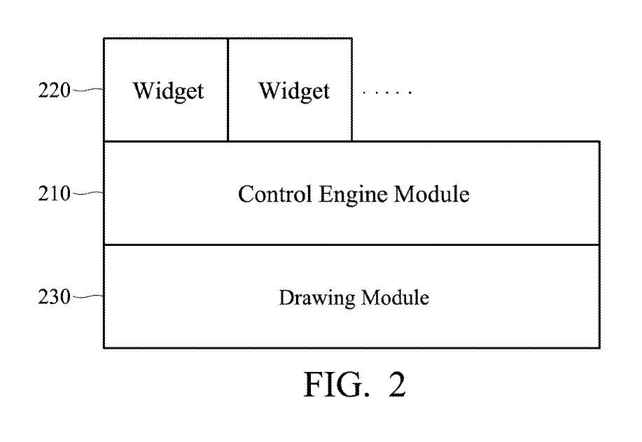

FIG. 2 is a block diagram illustrating the software architecture of a widget system according to an embodiment of the invention. The software architecture comprises a control engine module 210 providing a widget system framework for enabling execution of widgets, which is loaded and executed by the processing unit 13. The widget system framework functions as a hosting platform with necessary underlying functionalities for the operation of the widgets. Also, the software architecture comprises a widget 220 having an image which is initially displayed within a first area on the touch screen 16. Specifically, the widget 220 is associated with an application, and performs its own functions and has its own behaviors according to an application when enabled (also referred to as initialized) by the control engine module 210. A drawing module 230 draws the image of the widget 220 on a specific position as a graphical interface to users to interact with, instructed by the control engine module 210. For example, the image of the widget 220 may be a virtual clock, a virtual calendar, or a representative icon of the widget 220, etc. There may be sensors (not shown) disposed on or under the touch screen 16 for detecting a touch or approximation thereon. The touch screen 16 may comprise a sensor controller for analyzing data from the sensors and accordingly determining pen down, long press, drag and pen up events on a specific coordinate (x, y). The determination may be alternatively accomplished by the control engine module 210 while the sensor controller is responsible for repeatedly outputting sensed coordinates of one or more touches or approximations. The control engine module 210 may further determine one widget whose image covers the coordinate of the pen down or long press event (may refer to as a tap event interchangeably) and report the pen down or long press event to the determined widget. Then, the pen move (may refer to as a drag event interchangeably) events may be continuously reported to the determined widget when touches or approximations are continuously detected at successive coordinates. When no further touch or approximation is detected, the control engine module 210 may report a pen up event (may refer to as a drop event interchangeably) to the determined widget. The pen down, pen move and pen up events in series may refer to as a drag and drop operation. The determined widget may perform particular tasks in response to the received events. Once detecting the pen down or long press event, the control engine module 210 may update parameters of the image 300 of the determined widget to add a UI effect, such as blurring, enlarging and/or shadowing the image, or changing the expressive color of the image, or others, to prompt users which widget is selected, and then, deliver the updated parameters of the image 300 to the drawing module 230 to draw the updated image 300. The control engine module 210 may continuously update current coordinates of the image 300 to the drawing module 230 when detecting pen move events thereon, enabling the drawing module 230 to draw the image 300 on corresponding positions of a moving path. Once detecting the pen up event, the control engine module 210 recognizes that the dragging is finished and performs relevant operations to pull back the image 300 to a displayable area if required. Details of the operations for the pen up event are to be discussed as follows. The pen down, pen move and pen up events may also be referred to as a composite drag-and-drop event.

From a software implementation perspective, the control engine module 210 may, for example, contain one or more event handlers to respond to the mentioned pen events. The event handler contains a series of program codes and, when executed by the processing unit 13, updates parameters of the image 300 to be delivered to the drawing module 230 for altering its look and feel and/or updating display positions.

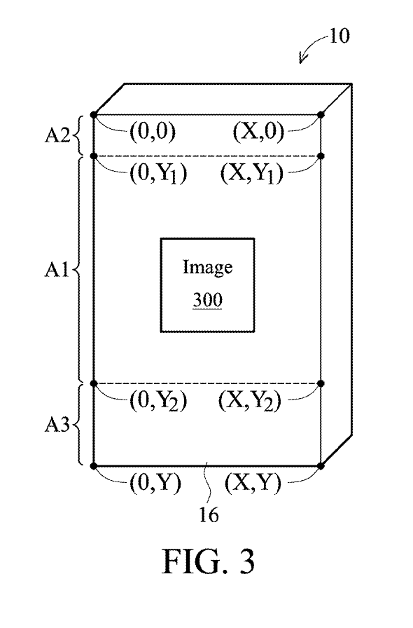

FIG. 3 is an exemplary display on the touch screen 16 according to an embodiment of the invention. In the embodiment, the display screen 16 is partitioned into 3 sections, i.e., the areas A1 to A3. The area A1, enclosed by coordinates (0, Y₁), (0, Y₂), (X, Y₁), and (X, Y₂), defines the displayable area where the image 300 of the widget 220 can be displayed therein; while the area A2, enclosed by coordinates (0, 0), (0, Y₁), (X, 0), and (X, Y₁), and area A3, enclosed by coordinates (0, Y₂), (0, Y), (X, Y₂), and (X, Y), respectively define the undisplayable areas where the image 300 cannot be displayed therein. The image 300 acts as a visual appearance for the widget 220 to interact with users. For example, the area A2 may be used to display the system statuses, such as currently enabled functions, phone lock status, current time, remaining battery power, and so on. The area A3 may be used to display the widget/application menu, which contains multiple widget and/or application icons, prompting users to select a widget or application to use. The widget is a program that performs simple function when executed, such as providing a weather report, stock quote, playing an animation on the touch screen 16, or others. As shown in FIG. 3, the image 300 originally appears to be within the area A1, when the widget 220 is enabled by the control engine module 210. For viewing or operating concerns, a user may rearrange the displayed elements on the touch screen 16 by using an object, such as a pointer, a stylus, or a finger, to drag the image 300 from the current position to any other position on the touch screen 16. It is noted that, users may drag the image 300 into the area A2 or A3, resulting in disappearance of the image 300 from the area A1 or presenting only a small portion of the image 300 in the area A1, which is difficult to be observed by users. It causes that users feel inconvenient to view or tap the image 300, or mistakenly think that the widget 220 is failed, killed or removed from the mobile phone 10. To address the above problems, the control engine module 210 may trigger one or more subsequent drawings for the image 300 to enable that the whole image 300 or a predetermined portion of the image 300 can be displayed in the area A1.

From the perspective of users, the drag-and-drop of the image 300 on the touch screen 16 may start with a touch or approximation on the image 300 on the touch screen 16, followed by several continuous touches or approximations on a series of successive positions of the touch screen 16 for moving the image 300, and end with the object being no longer touching or approximating the touch screen 16. Generally, the continuous touches on the touch screen 16 may be referred to as position updates of the drag events, and then, the moment at which detects no touch or approximation on the touch screen 16 may be referred to that a termination of the drag events or a drop event (also referring to as a pen up event from a particular widget image) occurs. Note that, the drop position may be considered as the last detected position, or a forecast based on the previously detected positions. In response to the drag events (also referring to as a pen move event on a particular widget image), the control engine module 210 continuously updates the display positions of the image 300 and notifies the drawing module 230 of the updated ones. The control engine module 210 may further modify parameters of the image 300 to put some UI effects, such as making the image 300 more blurry or transparent than its original appearance, or others, to let users perceive that the image 300 is being moved. When the drop position is detected within the undisplayable area, i.e. the area A2 or A3, and a predetermined part of the image 300 or a specific point of the image 300 cannot be displayed in the area A1, the control engine module 210 further calculates a target position at which the predetermined part or the specific point of the image 300 can be displayed, and controls the drawing module 230 to draw the image 300 in the calculated position to avoid losing control over the widget 220. The predetermined part may be configured as the half, one-third, or twenty-five percent of the upper, lower, left or right part of the image 300, or others, depending on system requirements. The specific point of the image 300 may be configured as the center point, or other, depending on system requirements. The control engine module 210 may further calculate intervening positions between the drop position and the target position, and trigger the drawing module 230 to draw the image 300 therein in series after the termination of the drag event to let users feel that the image 300 is moved toward the target position.

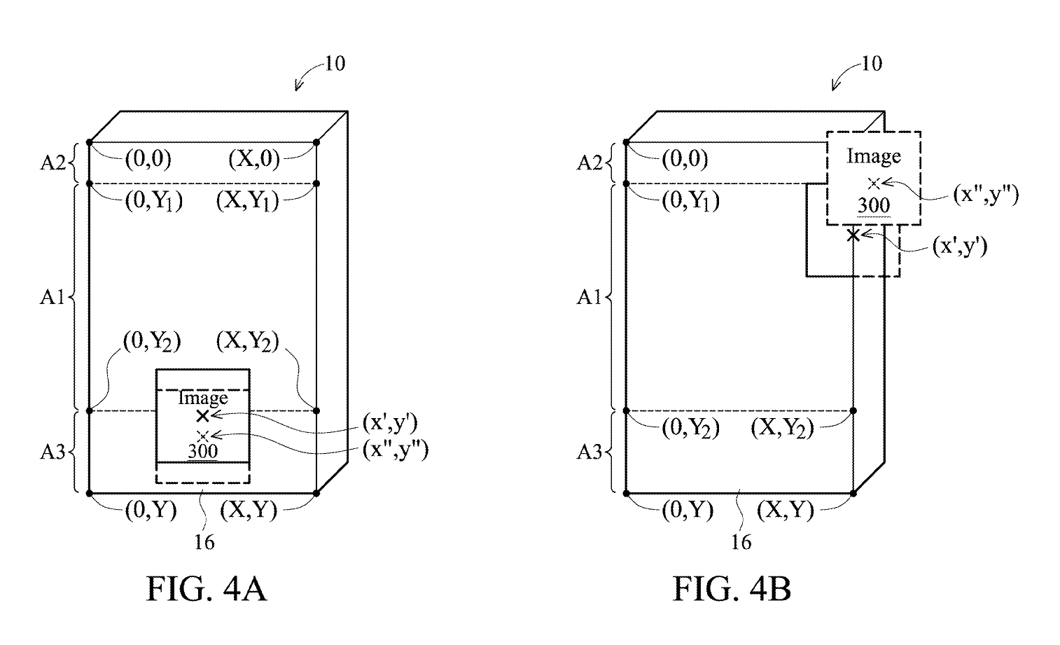

To further clarify, when the termination of the drag event is detected (i.e. the pen up or drop event) via the corresponding event handler, the control engine module 210 first determines whether the predetermined part of the image 300 or the specific point of the image 300 cannot be displayed in the area A1. If so, the control engine module 210 determines a target position within the first area A1, and may further determine one or more intervening positions. Specifically, the target position is determined according to the information of the area A1 and the drop position where the termination of the drag events occurs. For example, the target position may be within the area A1 and is closest to the drop position. In one embodiment, the drop position may indicate the center of the image 300 as a positioning reference point. FIG. 4A is a schematic diagram illustrating adjustment for the dropped image 300 whose center is in the area A3. Assume that the drop position is denoted as (x″, y″), which corresponds to the center of the image 300, the target position being denoted as (x′, y′) may be calculated with x′=x″ and y′=Y₂. That is, the x-axis of the target position remains unchanged and the y-axis of the target position is set to the bottom row of the area A1, resulting in the image 300 is upward moved until its center falls within the area A1. FIG. 4B is a schematic diagram illustrating adjustment for the dropped image 300 whose center is outside of the touch screen 16. Similarly, with (x″, y″) and (x′, y′) being the coordinates of the drop position and the target position, respectively, the adjusted position may be calculated with x′=X and

$${y}^{′} = {Y}_{1} + ( \frac{widget height}{2} ) .$$

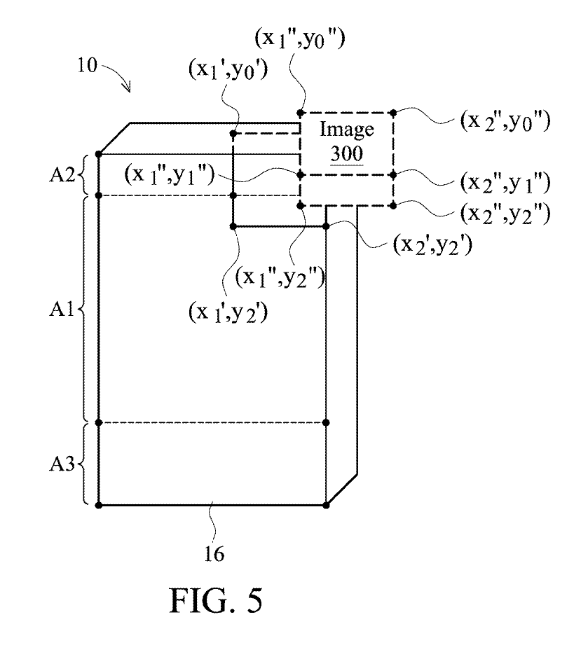

That is, the x-axis of the target position is set to the rightmost column of the area A1 and the y-axis of the target position is set under the top row of the area A1 for the half of the widget height, resulting in the image 300 is moved toward to the calculated lower-left position. In other embodiments, a predetermined part of the image 300 may be a critical part for the widget 220, which is should be constantly displayed in the area A1, that is, cannot be moved out of the area A1. Note that the predetermined part of the image 300 may be determined as being not within the area A1, if the entire predetermined part does not fall within the area A1. In other words, the predetermined part of the image 300 may be determined as being not within the area A1, even if only a slight fraction of the predetermined part falls within the area A2 or A3. FIG. 5 is a schematic diagram illustrating adjustment for the dropped image 300 whose predetermined part is partially outside of the touch screen 16. In this embodiment, the dropped image 300 may be enclosed by coordinates (x₁″, y₀″), (x₁″, y₂″), (x₂″, y₀″), and (x₂″, y₂″), wherein the predetermined part of the image 300 may enclosed by coordinates (x₁″, y₁″), (x₁″, y₂″), (x₂″, y₁″), and (x₂″, y₂″). Regarding the determination of the target position for the image 300 containing a predetermined part, exemplary pseudo code is addressed below, enabling the drawing module 230 to draw the predetermined part of the image 300 within the area A1 accordingly.

```
Target Position Determination Algorithm {
  if (y₁″<Y₁) {
    y₀′= y₀″+ (Y₁−y₁″);
    y₂′= y₂″+ (Y₁−y₁″);
  }
  if (y₂″>Y₂) {
    y₀′= y₀″− (y₂″−Y₂);
    y₂′= Y₂;
  }
  if (x₁″>X) {
    x₂′= X;
    x₁′= X − (x₂″−x₁″);
  }
  if (x₁″<0) {
    x₁′= 0;
    x₂′= (x₂″−x₁″);
  }
}
```

Regarding the position updates of the image 300 of the widget 220 responding to the pen move event (or the drag event), exemplary pseudo code is addressed below:

```
function DetectEvents( );
{
  while (infinite loop)
  {
    if (pen is active)
    {
      get my widget position;
      get active pen event type and position;
      if (pen type == move)
      {
        change my widget position to the pen position;
      }
    }
    if (stop detecting signal is received)
    {
      return;
    }
  }
}
```

In addition, an additional animation (i.e. movement) may be provided to pull the image 300 back to the area A1. The animation may show that the image 300 is shifted gradually from the drop position straight to the target position. The moving speed of the animation may be at a constant rate or variable rates, such as decreased rates, as the image 300 moves toward the target position. The animation may show that the image 300 is shifted at rates compliant with the Bézier curve. Exemplary pseudo code for the animation contains three exemplary functions for computing the next position in which the image 300 is to be displayed. Those skilled in the art may select one to play animation. When executing the function “constant_speed_widget_position”, the image 300 is moved at a constant rate. When executing the function “approximate_ease_out_widget_position”, the image 300 is moved based on the ease out formula. When executing the function “approximate_bezier_ease_out_widget_position”, the image is moved using Bézier curve.

```
AnimationEffect Algorithm
{
  time = 0 ~ 1;
  (x0, y0) = current position in which the image being currently
  displayed;
  (x1, y1) = target position;
  function constant_speed_widget_position (time)
  {
    x = x0 + (x1 − x0) * time;
    y = y0 + (y1 − y0) * time;
  }
  function approximate_ease_out_widget_position (time)
  {
    s = 1 − (1 − time) * (1 − time) * (1 − time);
    x = x0 + (x1 − x0) * s;
    y = y0 + (y1 − y0) * s;
  }
  function approximate_bezier_ease_out_widget_position (time)
  {
    p0 = 0;
    p1 = 0.9;
    p2 = 1;
    s = p0 + 2 * (p1 − p0) * time + (p0 − 2 * p1 + p2) * time * time;
    x = x0 + (x1 − x0) * s;
    y = y0 + (y1 − y0) * s;
  }
}
```

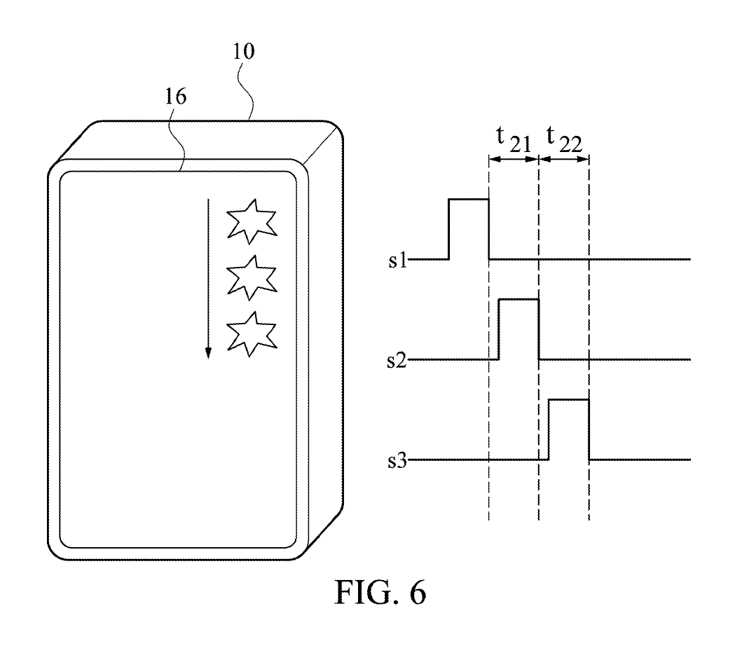

It is noted that the drag event may indicate a plurality of continuous contacts of an object on the touch screen 16 and may be interchangeably referred to as a slide event. The contacts of the object may be referred to as sensed approximation of the object to the touch screen 16, and is not limited thereto. Additionally, the drag event may be in any direction, such as upward, downward, leftward, rightward, clockwise, counterclockwise, or others. FIG. 6 shows a schematic diagram of a drag event with signals s1 to s3 on the touch screen 16 according to an embodiment of the invention. The signals s1 to s3 represent three continuous contacts detected in sequence by the sensor(s) (not shown) disposed on or under the touch screen 16. The signal s1 may be generated by a touch down of an object on the touch screen 16, the signal s2 may be generated by a continued contact subsequent to the touch down, and the signal s3 may be generated by a drop of the object from the touch screen 16. The time interval t₂₁ between the termination of the first and second touches, and the time interval t2₂ between the termination of the second and third touches are obtained by detecting the changes in logic levels. Although in a linear track in this embodiment, the continuous touches may also be in a non-linear track in other embodiments.

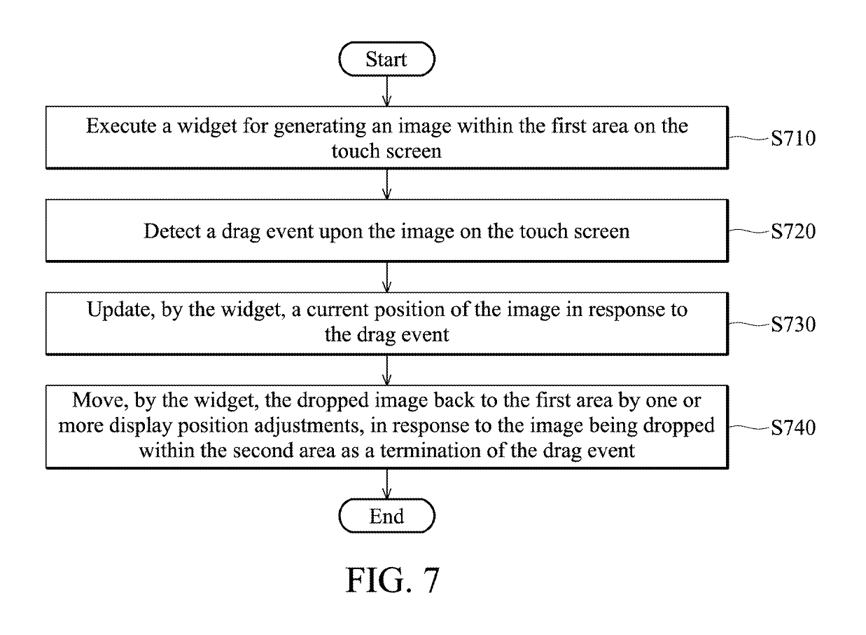

FIG. 7 is a flow chart illustrating the position adjustment method for widget presentations in the mobile phone 10 according to an embodiment of the invention. When the mobile phone 10 is started up, a series of initialization processes, including booting up of the operating system, initializing of the control engine module 210, and activating of the embedded or coupled peripheral modules (such as the touch screen 16), etc., are performed. Subsequently, the widget 220 may be created and initialized via the control engine module 210 in response to user operations, and further enabled by the control engine module 210. After being enabled by the control engine module 210, the widget 220 generates the image 300 within the first area on the touch screen 16 (step S710). In this embodiment, the touch screen 16 is partitioned into a first area and a second area, wherein the first area may be referred to as a displayable area, such as the area A1 of FIG. 3, and the second area may be referred to as an undisplayable area, such as the area A2 or A3 of FIG. 3. Later on, a user may move the image 300 from its initial position to another position on the touch screen 16 by using an object, and a drag event upon the image 300 on the touch screen 16 is detected (step S720). Subsequently, the control engine module 210 updates the current position of the image 300 in response to the drag event (step S730). In response to the image 300 being dropped within the second area as a termination of the drag event, the control engine module 210 further moves the dropped image 300 back to the first area by one or more display position adjustments (step S740). To be more specific, it is determined by the control engine module 210 whether the drop position of the image 300 is within the area A2 or A3. If so, a target position within the area A1 is determined and the image 300 is shifted from the drop position to the target position. An additional animation may be provided to show position adjustment for the dropped image 300. The animation-may show that the image 300 is shifted gradually from the drop position straight to the target position. The moving speed of the animation may be at a constant rate or variable rates, such as decreased rates, as the image 300 moves toward the target position. The animation may show that the image 300 is shifted at speed rates compliant with the Bézier curve. The control for pulling back a widget image, which has been dropped to a undisplayable area, specified in mentioned algorithms, process flow, or others, may be alternatively implemented in a drop event handler of the widget 220, and the invention should not be limited thereto.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic interaction apparatus, comprising:
a touch screen comprising a first area and a second area;
a processing unit determining that an image of a widget is dragged and dropped within the second area, and adjusting the dropped image back to the first area.

2. The electronic interaction apparatus of claim 1, wherein the processing unit obtains a center of the image when detecting a termination of a series of drag events for the widget, and determines that the image of the widget is dragged and dropped within the second area when the center of the image is within the second area.

3. The electronic interaction apparatus of claim 1, wherein the processing unit obtains a predetermined part of the image when detecting a termination of a series of drag events for the widget, and determines that the image of the widget is dragged and dropped within the second area when the predetermined part of the image is not fully within the first area.

4. The electronic interaction apparatus of claim 1, wherein the image of the widget acts as a visual appearance for the widget to interact with an user, can be displayed within the first area and cannot be displayed within the second area.

5. The electronic interaction apparatus of claim 1, wherein the processing unit further calculates a target position within the first area and moves the dropped image toward the target position.

6. The electronic interaction apparatus of claim 5, wherein the image is dropped in a drop position, and processing unit further calculates at least one intervening position between the drop position and the target position, and moves the dropped image toward the target position through the intervening position.

7. The electronic interaction apparatus of claim 6, wherein the image is moved at a constant rate.

8. The electronic interaction apparatus of claim 7, wherein the next of the intervening position is calculated by following equations:
x=x0+(x1−x0)*time; and
y=y0+(y1−y0)*time,
in which “time” represents a value between 0 and 1, (x0, y0) represents a current position in which the image being currently displayed, the current position is the drop position or one intervening position, and (x1, y1) represents the target position.

9. The electronic interaction apparatus of claim 6, wherein the image is moved at variable rates.

10. The electronic interaction apparatus of claim 9, wherein the next of the intervening position is calculated by following equations:
s=1−(1−time)*(1−time)*(1−time);
x=x0+(x1−x0)*s; and
y=y0+(y1−y0)*s,
in which “time” represents a value between 0 and 1, (x0, y0) represents a current position in which the image being currently displayed, the current position is the drop position or one intervening position, and (x1, y1) represents the target position.

11. The electronic interaction apparatus of claim 9, wherein the next of the intervening position is calculated by following equations:
p0=0;
p1=0.9;
p2=1;
s=p0+2*(p1−p0)*time+(p0−2*p1+p2)*time*time;
x=x0+(x1−x0)*s; and
y=y0+(y1−y0)*s,
in which “time” represents a value between 0 and 1, (x0, y0) represents a current position in which the image being currently displayed, the current position is the drop position or one intervening position, and (x1, y1) represents the target position.

12. A method for position adjustment of widget presentations in an electronic interaction apparatus with a touch screen comprising a first area and a second area, the position adjustment method comprising:
determining that an image of a widget is dragged by detecting a series of continuous contacts or approximations of an object on an image of the widget displayed on the touch screen;
detecting that the image is dragged and dropped within the second area at a termination of the dragging; and
moving the dropped image back to the first area.

13. The method of claim 12, wherein the detecting step further comprises obtaining a center of the image when detecting the termination of the dragging, and the moving step further comprises:
calculating a target position within the first area; and
moving the center of the image toward the target position.

14. The method of claim 12, wherein the detecting step further comprises obtaining a predetermined part of the image when detecting the termination of the dragging, and the moving step further comprises:
calculating a target position within the first area; and
moving the predetermined part of the image toward the target position.

15. The method of claim 14, wherein the predetermined part of the image is constantly displayed in the first area to interact with a user for the widget.

16. The method of claim 12, wherein the image of the widget acts as a visual appearance for the widget to interact with an user, can be displayed within the first area and cannot be displayed within the second area.

17. The method of claim 12, wherein the moving step further comprises showing an animation to move the dropped image back to the first area on the touch screen.

18. The method of claim 12, wherein the detecting step further comprises obtaining a drop position when detecting the termination of the dragging, and the moving step further comprises:
calculating at least one intervening position between the drop position and the target position; and
moving the dropped image toward the target position through the intervening position.

19. The method of claim 18, wherein the drop position is the last position in which the image displayed during dragging.

20. The method of claim 18, wherein the drop position is a forecast based on a plurality of previous positions in which the image displayed during dragging.
